(19) United States
(12) Patent Application Publication
(10) Pub. No.: US 2023/0070455 A1
(43) Pub. Date: Mar. 9, 2023

(54) DEVICES, METHODS, APPARATUS AND COMPUTER READABLE STORAGE MEDIA FOR SERVICE MANAGEMENT IN A COMMUNICATION SYSTEM

(71) Applicant: Nokia Technologies Oy, Espoo (FI)

(72) Inventors: Zhi WANG, Qingdao (CN); Qingbo ZHANG, Qingdao (CN)

(21) Appl. No.: 17/797,002

(22) PCT Filed: Feb. 10, 2020
(86) PCT No.: PCT/CN2020/074662

§ 371 Date: Aug. 2, 2022

(51) Int. Cl. H04W 48/18; H04L 41/50

(52) U.S. Cl. CPC H04W 48/18; H04L 41/5058

(57) ABSTRACT

Devices, methods, apparatus and computer readable storage media for service management in a communication system are provided. The method comprises determining, at a first device, a set of candidate service providers for providing a service to a second device in place of a current service provider based on a mapping between the second device and a plurality of service providers having an ability to provide the service (310) and transmitting a message indicating the set of candidate service providers to the second device (320). In this way, an optimized function maintenance solution under service-based system architecture can be realized, thereby enhancing network stability and improving system performance.

### FIELD

Embodiments of the present disclosure generally relate to the field of telecommunication and in particular, to devices, methods, apparatus and computer readable storage media for service management in a communication system.

### BACKGROUND

The 3rd Generation Partnership Project (3GPP) defines the 5th-Generation (5G) System Architecture as a Service Based Architecture. In the system architecture, the system functionality is achieved by a set of Network Functions (NFs) providing services to other authorized NFs to access their services.

The NFs may offer different functionalities and thus different NF services. Each of the NF services offered by a NF shall be self-contained, acted upon and managed independently from other NF services offered by the same NF.

The Network Repository Function (NRF) supports the corresponding functionalities, such as receiving NF Discovery Request from a NF instance, providing the information of the discovered NF instances (be discovered) to the NF instance and maintaining the NF profile of available NF instances and their supported services.

### SUMMARY

In general, example embodiments of the present disclosure provide a solution of for service management in a communication system.

In a first aspect, there is provided a method for service management in a communication system. The method comprises determining, at a first device, a set of candidate service providers for providing a service to a second device in place of a current service provider based on a mapping between the second device and a plurality of service providers having an ability to provide the service and transmitting a message indicating the set of candidate service providers to the second device.

In a second aspect, there is provided a method for service management in a communication system. The method comprises receiving, at a second device and from a first device, a message indicating a set of candidate service providers having an ability to provide a service requested by the second device and selecting a target service provider for providing the service to the second device from set of candidate service providers.

In a third aspect, there is provided a first device. The first device comprises at least one processor; and at least one memory including computer program codes; the at least one memory and the computer program codes are configured to, with the at least one processor, cause the first device at least to perform the method according to the first aspect.

In a fourth aspect, there is provided a second device. The second device comprises at least one processor; and at least one memory including computer program codes; the at least one memory and the computer program codes are configured to, with the at least one processor, cause the first device at least to perform the method according to the second aspect.

In a fifth aspect, there is provided an apparatus for service management in a communication system. The apparatus comprises means for determining, at a first device, a set of candidate service providers for providing a service to a second device in place of a current service provider based on a mapping between the second device and a plurality of service providers having an ability to provide the service; and means for transmitting a message indicating the set of candidate service providers to the second device.

In a sixth aspect, there is provided an apparatus for service management in a communication system. The apparatus comprises means for receiving, at a second device and from a first device, a message indicating a set of candidate service providers having an ability to provide a service requested by the second device; and means for selecting a target service provider for providing the service to the second device from set of candidate service providers.

In a seventh aspect, there is provided a computer readable medium having a computer program stored thereon which, when executed by at least one processor of a device, causes the device to carry out the method according to the first aspect.

In an eighth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a schematic diagram illustrating a process for service management in a communication system according to example embodiments of the present disclosure;

FIG. 3 shows a flowchart of an example method for service management in a communication system according to some example embodiments of the present disclosure;

FIG. 4 shows a flowchart of an example method for service management in a communication system according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the UE include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure. The UE may also correspond to Mobile Termination (MT) part of the integrated access and backhaul (IAB) node (a.k.a. a relay node).

As used herein, the term “network device” refers to a device via which services can be provided to a terminal device in a communication network. As an example, the network device may comprise a base station. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like. A relay node may correspond to Distributed Unit (DU) part of the IAB node.

As used herein, the term “circuitry” may refer to one or more or all of the following:

(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

As described above, the 3rd Generation Partnership Project (3GPP) defines the 5th-Generation (5G) System Architecture as a Service Based Architecture. The 5G core network (5GC) is fundamental to the commercial success of 5G. In addition to the basic functions needed to setup/manage user session, it enables new and diverse services across many different vertical industries. The Service Based Architecture for 5GC under development in the 3GPP and across industry offers many attributes that make it suitable for progressive operators seeking to accelerate deployment of cloud-native 5G networks and services.

In the system architecture, the system functionality is achieved by a set of Network Functions (NFs) providing services to other authorized NFs to access their services. A NF service is one type of capability exposed by a NF (can be referred to as a NF Service Provider) to other authorized NF (can be referred to as a NF Service Consumer) through a service based interface. A NF service may support one or more NF service operation(s).

The NFs may offer different functionalities and thus different NF services. Each of the NF services offered by a NF shall be self-contained, acted upon and managed independently from other NF services offered by the same NF.

A NF within the 5G Core network may expose its capabilities as services via its service based interface, which can be re-used by CN NFs. The NF service discovery enables a CN NFs to discover NF instance(s) that provide the expected NF service(s).

The Network Repository Function (NRF) supports the corresponding functionalities, such as receiving NF Discovery Request from a NF instance, providing the information of the discovered NF instances (be discovered) to the NF instance and maintaining the NF profile of available NF instances and their supported services.

In TS 23.502, the NRF service operations are defined in the following table.

TABLE 1
NRF service operations

| Service Name | Service Operations | Operation Semantics | Example Consumer(s) |
|---|---|---|---|
| Nnrf_NFManagement | NFRegister | Request/Response | AMF, SMF, UDM, AUSF, NEF, |
| | | | PCF, SMSF, NSSF, UPF, BSF, |
| | | | CHF |
| | NFUpdate | Request/Response | AMF, SMF, UDM, AUSF, NEF, |
| | | | PCF, SMSF, NSSF, UPF, BSF, |
| | | | CHF |
| | NFDeregister | Request/Response | AMF, SMF, UDM, AUSF, NEF, |
| | | | PCF, SMSF, NSSF, UPF, BSF, |
| | | | CHF |
| | NFStatusSubscribe | Subscribe/Notify | AMF, SMF, PCF, NEF, NSSF, |
| | | | SMSF, AUSF, CHF, NRF |
| | NFStatusNotify | | AMF, SMF, PCF, NEF, NSSF, |
| | | | SMSF, AUSF, CHF |
| | NFStatusUnSubscribe | | AMF, SMF, PCF, NEF, NSSF, |
| | | | SMSF, AUSF, CHF, NRF |
| Nnrf_NFDiscovery | Request | Request/Response | AMF, SMF, PCF, NEF, NSSF, |
| | | | SMSF, AUSF, CHF, NRF |
| Nnrf_AccessToken | Get | Request/Response | AMF, SMF, PCF, NEF, NSSF, |
| | | | SMSF, AUSF, UDM |

To enable the NRF to maintain the information of available NF instances and services they can support, each NF instance informs the NRF of the list of NF services that it can support. The NF instance may also de-registers from the NRF when it is about to gracefully shut down or disconnect from the network in a controlled way. Besides the registration and the de-registration, the service update of a NF may also be used to inform NRF if there is any state change of its service.

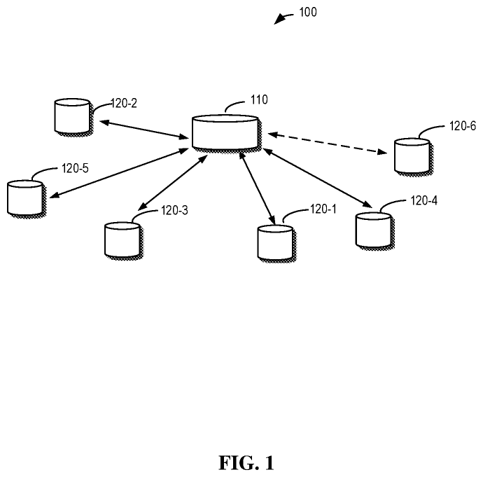

FIG. 1 illustrates an example environment in which example embodiments of the present disclosure can be implemented.

As shown in FIG. 1, the environment 100 comprise a NRF 110 (hereinafter may also be referred to as a first device 110) and a plurality of NFs 120-1, 120-2, 120-3, 120-4, 120-5 and 120-6. As described above, some of NFs may be referred to as NF consumers that request a specific service and some of NFs may be referred to as NF providers that provide a specific service they can support. It is to be understood that a NF consumer may also be referred to as a NF provider for providing a service and a NF provider may also be referred to as a NF consumer that requests a service provided by other NF providers. It is to be understood that the number of NFs shown in FIG. 1 is given for the purpose of illustration without suggesting any limitations. The environment 100 may include any suitable number of NFs.

For example, the NFs 120-1 and 120-2 in FIG. 1 can be considered as NF consumers and the NFs 120-3 to 120-6 can be considered as NF providers. Assuming the NFs 120-3, 120-4 and 120-5 have been registered at the NRF 110, when the NF 120-1 request a service, the NF 120-1 may transmit NF Discovery Request to the NRF 110 to initial a Discovery procedure at the NRF 110. The NF discovery request may comprise a set of the criteria associated with the service. Based on the set of the criteria, the NRF 110 may discover, from the registered NFs 120-3, 120-4 and 120-5, available NFs as the NF providers for providing the service request by the NF 120-1. For example, if the NRF 110 determines that the NFs 120-3 and 120-4 are available NFs for providing the service request by the NF 120-1, the NRF 110 may allocate the NFs 120-3 to the NF 120-1, to cause the service to be provided to the NF 120-1.

In view of above, in the SBA, once a NF registers its services with the NRF, the NF may simply expose services that any authorized consumer can consume without defining a new point-to-point interface and the procedures between the two network functions as required, which may offer the network operator a greater flexibility and more efficiency by decoupling the service consumer from the service provider. In SBA, different functions can be composed into an end-to-end service over standardized applications programming interfaces (APIs), which may be simpler for adding, removing, or modifying Virtual Network Functions (VNFs) from a network processing path (functional agility) and create new service-specific paths on-demand (service agility).

The 5G SBA has implicitly provided the solution for network stability by enabling NF consumer to subscribe the status of NF provider. However, once NFStatusNotify is received with the indication of the failure of NF provider, another NFDiscovery session will be triggered by NF consumer to find a new appropriate available NF provider, which may cause problems with this solution. For example, though 5G SBA implicitly provide the solution for network stability, that is, enabling NF consumer to subscribe the status of NF producer, once NFStatusNotify is received with the indication of the failure of NF producer, another NFDiscovery session will be triggered by NF consumer to find a new appropriate available NF producer, there are many problems with this solution.

For example, the NF consumer is required to subscribe the status change of its NF provider. Otherwise, the solution cannot work. When the NFStatusNotify of the NF provider indicating a failure of the NF provider is received, the handling for changing the NF provider depends largely on the behavior of NF consumers itself. It doesn't work if the NF consumer failed to trigger another NFDiscovery session because of its implementation or local provisioning issue. Furthermore, for handing the different network failure scenario, the implementation of NF consumer complicated may become complicatedly.

Moreover, a one key problem is that the recovery handling for network failure cannot be rapid, effective and unified performed. Considering the failure of a NF provider serving multiple NF consumers, the recovery handling for the service failure cannot be guarantee at each NF consumer in given time window.

Therefore, the embodiments of the present disclosure proposed a method for service management in a communication system. In this solution, the NRF 110 may maintain a mapping between the NF consumer and a plurality of NV provider having the ability to provide the service requested by the NF consumer after the normal NF discovery procedure for the NF consumer is completed. In this way, an optimized function maintenance solution under service-based system architecture can be realized, thereby enhancing network stability and improving system performance.

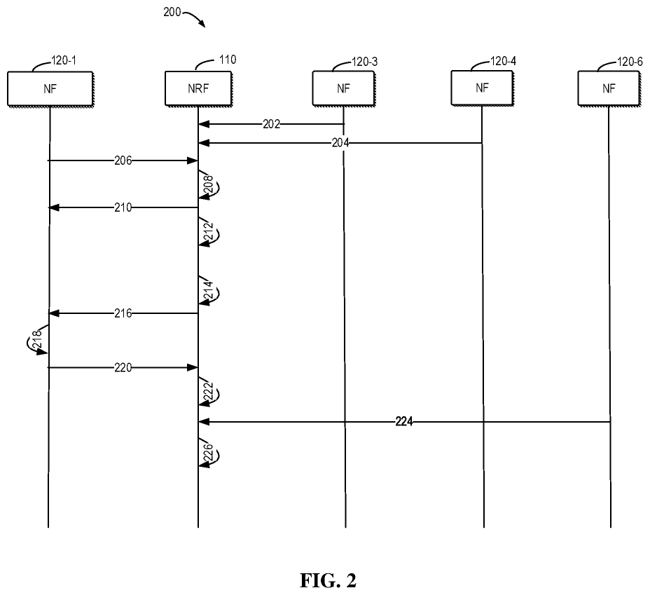

Principle and implementations of the present disclosure will be described in detail below with reference to FIG. 2, which shows a schematic diagram for service management in a communication system. For the purpose of discussion, the process 200 will be described with reference to FIG. 2. The process 200 may involve the NRF 110 and NF 120-1, NF 120-3, 120-4 and 120-6 as illustrated in FIG. 1.

As shown in FIG. 2, when the NF 120-3 and the NF 120-4 register at the NRF 110, the NF 120-3 and the NF 120-4 may for example transmit 202, 204 attribute information of the NF 120-3 and the NF 120-4 to the NRF 110. For example, the attribute information may relate to the ability of providing the service they can support, such as throughout, latency, reliability, network bandwidth, CPU, Memory, etc. Such attribute information may be stored in the NRF 110.

When the NF 120-1 expects to use a service, the NF 120-1 may transmit 206 a request for the expected service to the NRF 110. The request for the expected service may comprise the set of criteria for service characteristics, such as a service capability including throughout, latency, reliability, network bandwidth, CPU, Memory, a working status including working load and stability, a vendor code of a NF providing the service and charging information of the service, etc.

The NRF 110 may determine 208 available service providers having the ability to provide the service based on the set of criteria. For example, the NRF 110 may determine the NFs 120-3 and 120-4 as the available service providers and the NF 120-3 for example may be allocated for the NF 120-1 for providing the service. The NRF 110 may transmit 210 a message indicating that the service is to be provided by the NF 120-3 to the NF 120-1. Alternatively, the NRF 110 may also report the determined available service providers to the NRF 110 and the NF 120-1 may select a current service provider, for example the NF 120-3, from the determined available service providers. Then the mapping between the NF 120-1 and its corresponding service provider 120-3 may be established and maintained at the NRF.

Although the NF 120-2 and its corresponding NF discovery procedure for the service request by the NF 120-2 is not shown FIG. 2, it is to be understood that acts 206, 208 and 210 can be performed between the NRF 110 and the NF 120-2. For example, the NRF 110 may determine the NFs 120-4 and 120-5 as the available service providers for the NF 120-2 and the NF 120-5 may be allocated for the NF 120-2 for providing the service requested by the NF 120-2. Similarly, the mapping between the NF 120-2 and its corresponding service provider 120-5 may also be established and maintained at the NRF.

The mappings between the NF consumers and its serving NF providers may be listed as below:

TABLE 2
mapping between the NF consumer and its serving NF provider

| NF provider | Service Requested | NF consumer |
|---|---|---|
| NF 120-3 | Service 1 | NF 120-1 |
| NF 120-5 | Service 2 | NF 120-2 |

Furthermore, the NRF 110 may also establish 212 a mapping between the NF 120-1 and its alternative NF provider. The alternative NF provider may be referred to as the remaining service providers in the determined available service providers other than the current service provider allocated for the NF 120-1, i.e. the NF 120-3. The NRF 110 may maintain the mapping between the NF 120-1 and its alternative NF provider. Furthermore, the mapping may also indicate the set of criteria associated with service and the requested service. That is, the mapping between the NF 120-1 and its alternative NF provider can be established based on the identifiers of alternative NF provider, the requested service and the set of criteria associated with service. Also, a similar act may be performed for the NF 120-2. The mapping between the NF consumer and its alternative NF provider may be represented as below:

TABLE 3
mapping between the NF consumer and its alternative NF provider

| | | | |
|---|---|---|---|
| Alternative NF | Interaction | Service | NF |
| Producer List | Criteria | Requested | Consumer |

| | | |
|---|---|---|
| NF 120-4 | Service 1 | NF 120-1 |
| NF 120-3 | Service 2 | NF 120-2 |

As shown in Table 3, the “Service Requested” field indicates the service that the NF Consumer wants to request from NF Provider. The “Interaction Criteria” field defines the criteria for service selection which can be composed by one or more criteria combination such as a service capability including throughout, latency, reliability, network bandwidth, CPU, Memory, a working status including working load and stability, a vendor code of a NF providing the service and charging information of the service, etc, as described above. It is to be understood that the “Service Requested” and “Interaction Criteria” fields are originally filled base on the NFDiscovery request, i.e. acts 208-212 shown in FIG. 2.

Base on the mapping between the NF consumer and its serving NF provider, the NRF 110 may monitor the serving state between the NF consumer and its corresponding NF provider providing the service request by the NF consumer. If the NRF 110 detects that the service provided by the current service provider is failed, for example, the NRF detects that the NF 120-3 cannot provide the service to the NF 120-1 anymore, the NRF 110 may obtain the alternative NF provider list from the mapping between the NF 120-1 and its alternative service provider and determine 214 at least one candidate service provider based on the alternative NF provider list. Then the NRF 110 may transmit 216 a message indicating the at least one candidate service provider to the NF 120-1 to introduce the NF 120-1 to select a candidate service provider in place of the current service provider.

As shown in table 3, it can be read that NF 120-4 can be considered as the candidate service provider for providing the service in place of the NF 120-3. Thus, a message indicating the NF 120-4 may be generated in the NRF 110 and transmit to the NF 120-1. This message may be referred to as an Alternative NF Producer request.

In this case, there is only the NF 120-4 as the alternative service provider in the alternative service provider list, after the NF 120-1 receives the message indicating the NF 120-4 from the NRF 110, the NF 120-1 may select 218 the NF 120-4 as the target service provider in place of the NF 120-3 and the transmit 220 the information about a target service provider. i.e. the NF 120-4 to the NRF 110.

It is to be understood that there are multiple candidate service providers in the alternative service provider list. After the NF 120-1 receives the message indicating the multiple candidate service providers from the NRF 110, the NF 120-1 may select one of the multiple candidate service providers as the target service provider in place of the NF 120-3 and the transmit the information about a target service provider to the NRF 110.

If the NRF 110 receives the information about a target service provider from the NF 120-1, the NRF may update 222 the mapping between the NF 120-1 and its alternative NF provider in the alternative service provider list by removing the target service provider from the alternative service provider list. Thus, the mapping shown in Table 3 may be updated to be a mapping shown in Table 4 as below:

TABLE 4
mapping between the NF consumer and its alternative NF provider

| | | | |
|---|---|---|---|
| Alternative NF | Interaction | Service | NF |
| Producer List | Criteria | Requested | Consumer |

| | | |
|---|---|---|
| | Service 1 | NF 120-1 |
| NF 120-3 | Service 2 | NF 120-2 |

It can be seen from the Table 4, although the NF 120-3 cannot provide the “Service 1” anymore, the NF 120-3 may still provide the “Service 2” to the NF 120-2, thus the mapping between the NF 120-2 and its alternative service provider NF 120-3 can be maintained.

In some example embodiments, if the NRF 110 detects that a new NF service provider have the ability to provide the service, for example, “Service 1” requested by the NF 120-1, the NRF 110 may update the mapping between the NF 120-1 and its alternative service provider by adding the new service provider to the alternative service provider list.

For example, as shown in FIG. 2, if a NF 120-6 registers 224 at the NRF 110 and the NRF 110 determines that the NF 120-6 has the ability to provide the “Service 1” requested by the NF 120-1 based on the set of criteria associated with the “Service 1,” the NRF 110 may update 226 the mapping between the NF 120-1 and its alternative NF provider by adding the NF 120-6 to the alternative service provider list.

Furthermore, if the NRF 110 determines that the ability to provide the “Service 1” is recovered at the NF 120-3, the mapping between the NF 120-1 and its alternative NF provider may be updated by adding the NF 120-1 to the alternative service provider list again. Moreover, if the NRF 110 detects a service upgrading of the NF 120-5 and determines that the ability to provide the “Service 1” is recovered at the NF 120-5 (shown in FIG. 1), the mapping between the NF 120-1 and its alternative NF provider may be updated by adding the NF 120-5 to the alternative service provider list.

Thus, the mapping shown in Table 4 may be updated to be a mapping shown in Table 5 as below:

TABLE 5
mapping between the NF consumer and its alternative NF provider

| | | | |
|---|---|---|---|
| Alternative NF | Interaction | Service | NF |
| Producer List | Criteria | Requested | Consumer |

| | | |
|---|---|---|
| NF 120-3, | Service 1 | NF 120-1 |
| NF 120-5, | | |
| NF 120-6 | | |
| NF 120-3 | Service 2 | NF 120-2 |

On the contrary, if the NRF 110 determines that the candidate service provider in the alternative list fails to provide the service, the NRF 110 may update the mapping between the NF consumer and its alternative NF provider by removing the failed candidate service provider. The failed candidate service provider may be referred as a candidate service provider that cannot support a specific service due to de-registration from the NRF 110, a degrading of the candidate service provider or an overload of the service at the candidate service provider, etc. For example, if the NRF 110 detects that the NF 120-5 is overload, the NRF 110 may update the mapping by removing the NF 120-5 from the alternative service provider list.

Thus, the mapping shown in Table 5 may be updated to be a mapping shown in Table 6 as below:

TABLE 6
mapping between the NF consumer and its alternative NF provider

| | | | |
|---|---|---|---|
| Alternative NF | Interaction | Service | NF |
| Producer List | Criteria | Requested | Consumer |

| | | |
|---|---|---|
| NF 120-3, | Service 1 | NF 120-1 |
| NF 120-6 | | |
| NF 120-3 | Service 2 | NF 120-2 |

In some example embodiments, the mapping between the NF consumer and its alternative NF provider may be updated by a new NF discovery request initialed from the NF 120-1. For example, if the NF 120-1 request the further service. For example, “Service 2,” the NF 120-1 may transmit a further request comprising a further set of criteria associated with “Service 2” to the NRF 110, then the NRF 110 may re-allocate a service provider having the ability to provide the “Service 2” and update the mapping between the NF 120-1 and its alternative service provider.

In this way, an optimized function maintenance solution under service-based system architecture can be realized, thereby enhancing network stability and improving system performance.

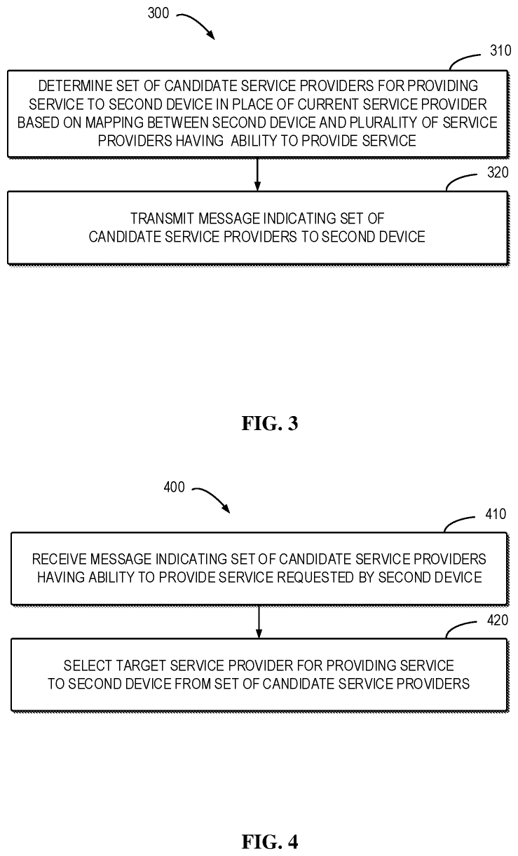

FIG. 3 shows a flowchart of an example method 400 for service management in a communication system. According to some example embodiments of the present disclosure. The method 300 can be implemented at the NRF 110 as shown in FIG. 1. For the purpose of discussion, the method 300 will be described with reference to FIG. 1.

As shown in FIG. 3, at 310, the NRF 110 determines a set of candidate service providers for providing the service to NF 120-1 in place of the current service provider based on a mapping between the NF 120-1 and a plurality of service providers having an ability to provide the service.

At 320, the NRF 110 transmits a message indicating the set of candidate service providers to the second device.

In some example embodiments, if the NRF 110 receives a request for the service from the NF 120-1, the NRF 110 may obtain, from the request, a set of criteria associated with attributes of the service and determine available service providers having the ability to provide the service based on the set of criteria. The NRF 110 may further establish the mapping based on the service, the set of criteria and identifiers of the available service providers other than the current service provider allocated to the second device for providing the service.

In some example embodiments, the set of criteria for service characteristics comprising at least one of a service capability, work status of the service, a software version of the service, a vendor code providing the service, and charging information of the service.

In some example embodiments, the NRF 110 may establish a further mapping between the NF 120-1 and the current service provider based on the service and an identifier of the current service provider and monitor a serving state between the NF 120-1 and the current service provider based on the further mapping.

In some example embodiments, if the NRF 110 detects a state change of the plurality of service providers, the NRF 110 may update the mapping by checking a matching status of the plurality of service providers for a set of criteria associated with attributes of the service.

In some example embodiments, the NRF 110 may receive, from the NF 120-1, information about a target service provider selected from the set of candidate service providers for providing the service to the NF 120-1. The NRF 110 may further obtain an identifier of the target service provider from the information and update the mapping based on the identifier of the target service provider.

In some embodiments, if the NRF 110 receives a further request for a further service from the NF 120-1, the NRF 110 may determine a further set of criteria associated with attributes of the further service from the further request and update the mapping at least based on the further set of criteria.

In some embodiments, the NRF 110 may comprise a management node and the NF 120-1 may comprise a network device or a terminal device.

FIG. 4 shows a flowchart of an example method 400 for service management in a communication system according to some example embodiments of the present disclosure. The method 400 can be implemented at the NF 120-1 as shown in FIG. 1. For the purpose of discussion, the method 400 will be described with reference to FIG. 1.

As shown in FIG. 4, at 410, the NF 120-1 receives, from the NRF 110, a message indicating a set of candidate service providers having an ability to provide a service requested by the second device.

At 420, the NF 120-1 selects a target service provider for providing the service to the NF 120-1 from set of candidate service providers.

In some embodiments, the NF 120-1 may generate information about the target service provider based on an identifier of the target service provider and transmits the information to the NRF 110.

In some example embodiments, the NF 120-1 may determine a set of criteria associated with attributes of the service and generate a request for the service comprising the set of criteria. The NF 120-1 may further transmit the request to the NRF 110.

In some embodiments, the NRF 110 may comprise a management node and the NF 120-1 may comprise a network device or a terminal device.

In some example embodiments, an apparatus capable of performing the method 300 (for example, implemented at the NRF 110) may comprise means for performing the respective steps of the method 300. The means may be implemented in any suitable form. For example, the means may be implemented in a circuitry or software module.

In some example embodiments, the apparatus comprises means for determining a set of candidate service providers for providing the service to a second device in place of a current service provider based on a mapping between the second device and a plurality of service providers having an ability to provide the service and means for transmitting a message indicating the set of candidate service providers to the second device.

The apparatus may further comprise means for in response to receiving a request for the service from the second device, obtaining, from the request, a set of criteria associated with attributes of the service; means for determining available service providers having the ability to provide the service based on the set of criteria; means for determining the current service provider from the available service providers; and means for establishing the mapping based on the service, the set of criteria and identifiers of the available service providers other than the current service provider allocated to the second device for providing the service.

In some example embodiments, the set of criteria for service characteristics comprising at least one of a service capability, work status of the service, a software version of the service, a vendor code providing the service, and charging information of the service.

The apparatus may further comprise means for establishing a further mapping between the second device and the current service provider based on the service and an identifier of the current service provider; and means for monitoring a serving state between the second device and the current service provider based on the further mapping.

The apparatus may further comprise means for in response to detecting a state change of the plurality of service providers, updating the mapping by checking a matching status of the plurality of service providers for a set of criteria associated with attributes of the service.

The apparatus may further comprise means for receiving, from the second device, information about a target service provider selected from the set of candidate service providers for providing the service to the second device; means for obtaining an identifier of the target service provider from the information and means for updating the mapping based on the identifier of the target service provider.

The apparatus may further comprise means for in response to receiving a further request for a further service from the second device, determining a further set of criteria associated with attributes of the further service from the further request and means for updating the mapping at least based on the further set of criteria.

In some embodiments, the NRF 110 may comprise a management node and the NF 120-1 may comprise a network device or a terminal device.

In some example embodiments, an apparatus capable of performing the method 400 (for example, implemented at the NF 120-1) may comprise means for performing the respective steps of the method 400. The means may be implemented in any suitable form. For example, the means may be implemented in a circuitry or software module.

In some example embodiments, the apparatus comprises means for receiving, from a first device, a message indicating a set of candidate service providers having an ability to provide a service requested by the second device and means for selecting a target service provider for providing the service to the second device from set of candidate service providers.

The apparatus may further comprise means for generating the information about the target service provider based on an identifier of the target service provider and means for transmitting the information to the first device.

The apparatus may further comprise means for determining a set of criteria associated with attributes of the service; means for generating a request for the service comprising the set of criteria; and means for transmitting the request to the first device.

In some embodiments, the NRF 110 may comprise a management node and the NF 120-1 may comprise a network device or a terminal device.

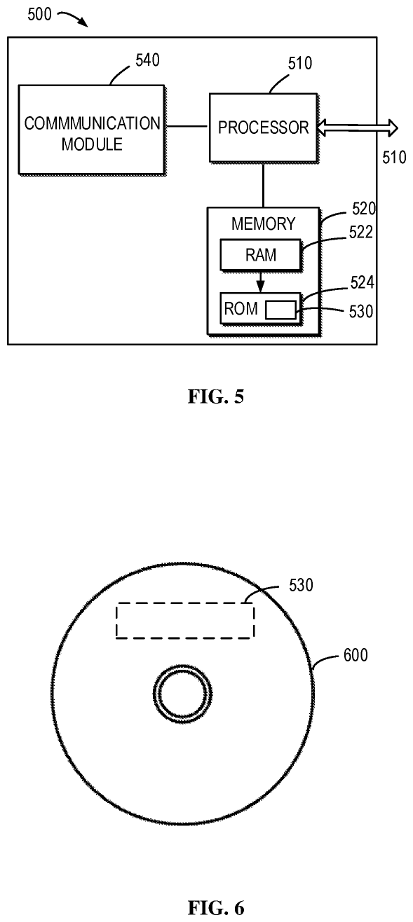

FIG. 5 is a simplified block diagram of a device 500 that is suitable for implementing embodiments of the present disclosure. The device 500 may be provided to implement the communication device, for example the NRF 110 and the NF 120-1 as shown in FIG. 1. As shown, the device 500 includes one or more processors 510, one or more memories 540 coupled to the processor 510, and one or more transmitters and/or receivers (TX/RX) 540 coupled to the processor 510.

The TX/RX 540 is for bidirectional communications. The TX/RX 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 520. The processor 510 may perform any suitable actions and processing by loading the program 530 into the RAM 520.

The embodiments of the present disclosure may be implemented by means of the program 530 so that the device 500 may perform any process of the disclosure as discussed with reference to FIGS. 2-4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300 and 400 as described above with reference to FIGS. 3-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-18. (canceled)

19. A method for service management in a communication system comprising:
receiving, at a second device and from a first device, a message indicating a set of candidate service providers having an ability to provide a service requested by the second device; and
selecting a target service provider for providing the service to the second device from set of candidate service providers.

20. The method of claim 19, further comprising:
generating the information about the target service provider based on an identifier of the target service provider; and
transmitting the information to the first device.

21. The method of claim 19, further comprising:
determining a set of criteria associated with attributes of the service;
generating a request for the service comprising the set of criteria; and
transmitting the request to the first device.

22. The method of claim 19, wherein the first device comprises a management node, and wherein the second device comprises a network device or a terminal device.

23. A second device comprising:
at least one processor; and
at least one memory including computer program codes;
the at least one memory and the computer program codes are configured to, with the at least one processor, cause the second device at least to perform: receiving, from a first device, a message indicating a set of candidate service providers having an ability to provide a service requested by the second device; and
selecting a target service provider for providing the service to the second device from set of candidate service providers.

24. The second device of claim 23, further comprising:
generating the information about the target service provider based on an identifier of the target service provider; and
transmitting the information to the first device.

25. The second device of claim 23, further comprising:
determining a set of criteria associated with attributes of the service;
generating a request for the service comprising the set of criteria; and
transmitting the request to the first device.

26. The second device of claim 23, wherein the first device comprises a management node, and wherein the second device comprises a network device or a terminal device.

27. A non-transitory computer readable medium comprising program instructions for causing a second device to perform:
receiving, from a first device, a message indicating a set of candidate service providers having an ability to provide a service requested by the second device; and
selecting a target service provider for providing the service to the second device from set of candidate service providers.
